(19) United States
(12) Patent Application Publication
(10) Pub. No.: US 2011/0167346 A1
(43) Pub. Date: Jul. 7, 2011

(54) METHOD AND SYSTEM FOR CREATING A MULTI-MEDIA OUTPUT FOR PRESENTATION TO AND INTERACTION WITH A LIVE AUDIENCE

(75) Inventors: Kin Mun Lye, Singapore (SG); Chieh Tseng Chong, Singapore (SG)

(73) Assignee: AGENCY FOR SCIENCE, TECHNOLOGY AND RESEARCH, Singapore (SG)

(21) Appl. No.: 12/919,364

(22) PCT Filed: Feb. 25, 2009
(86) PCT No.: PCT/SG2009/000066

§ 371 Date: Mar. 24, 2011

Related U.S. Application Data
(60) Provisional application No. 61/064,254, filed on Feb. 25, 2008.

(51) Int. Cl. G06F 3/00

(52) U.S. Cl. 715/716

(57) ABSTRACT

A method and system for creating a multi-media output for presentation to and interaction with a live audience. The method comprises the steps of playing a substantially continuous multi-media clip using a multi-media unit for substantially real-time display on a display unit; receiving, during the substantially real-time display of the multi-media clip, multi-media content from one or more persons in the live audience via one or more multi-media devices, wherein said multi-media devices are remotely coupled to the multi-media unit; providing a user interface of the multi-media unit for accessing and manipulating said received multi-media content; and incorporating at least a portion of said received multi-media content into the substantially continuous multi-media clip using the multi-media unit.

### FIELD OF INVENTION

The present invention relates broadly to a method and system for creating a multi-media output for presentation to and interaction with a live audience, and to a data storage medium having computer code means for instructing a computer device to execute a method of creating a multi-media output for presentation to a live audience.

### BACKGROUND

In the music industry, two genres of “jockey”-type performers have developed i.e. Disc Jockey (DJ) and Video Jockey (VJ). A DJ mixes music from his own collection while a VJ spins video visualisations from his own collection and presents music videos. A skilled DJ mixes music in real time but does not facilitate any interaction or communication between his audiences. The mode of communication is said to be uni-directional where input to the DJ system is from the DJ himself and is pre-existing before the performances.

This scenario is similar for a skilled VJ. A VJ mixes a variety of video sources together to create a unique video image, for example for display at large club events. A typical mix of images would be some pre-mixed DVDs of video images from previous events, abstract images such as proprietary visualizations, and live images from a video camera directed at the DJ or dancers in the audience, together with overlaying of text to for example display the name of the event, the VJ's name or messages input by the VJ. The images from the respective sources are mixed by the VJ using video mixer/switcher hardware, which controls the overlay of the separate sources on a single display depending on the selected input source and fading transitions between the sources, much like audio mixers.

More recently, with the emergence of in particular short message service (SMS) communications from and between handheld devices such as mobile phones, TV broadcasters have provided facilities to overlay SMS messages received at the broadcaster, for example audience comments overlaid during broadcast of a music video, using a ticker tape overlaid over the music video image. Again, video mixers/switches are used to overlay the SMS-based ticker tape source and the music video source such as a DVD or DV tape. While ticker tapes provide an opportunity for communication from the audience into the broadcasting, they are limited to textual impressions, and thus can be regarded as merely a technological extension from verbal feedback in talk-back TV over conventional telephone communications. Furthermore, the textual content is provided “as is” i.e. there is no provision for creative input by the moderator, thus leaving ticker tape broadcasting of limited interactive value.

The present invention has been made in the context of the above state of the art, and to seek to address a need for providing new ways of audience interaction, encompassing creativity and expression.

### SUMMARY

In accordance with a first aspect of the present invention there is provided a method of creating a multi-media output for presentation to and interaction with a live audience; the method comprising the steps of playing a substantially continuous multi-media clip using a multi-media unit for substantially real-time display on a display unit; receiving, during the substantially real-time display of the multi-media clip, multi-media content from one or more persons in the live audience via one or more multi-media devices, wherein said multi-media devices are remotely coupled to the multi-media unit; providing a user interface of the multi-media unit for accessing and manipulating said received multi-media content; and incorporating at least a portion of said received multi-media content into the substantially continuous multi-media clip using the multi-media unit.

The user interface may be further provided for manipulating said incorporated portion of said received multi-media content during playing of the substantially continuous multi-media clip.

The method may further comprise converting the received multi-media content into a format suitable for playback in an application program for playing the substantially continuous multi-media clip.

Incorporating said portion of said received multi-media content may comprise adding said portion of said received multi-media content as an object into said substantially continuous multi-media clip.

Said received multi-media content may be responsive to a previous multi-media content displayed on the display unit.

In accordance with a second aspect of the present invention there is provided a multi-media unit for creating a multi-media output for presentation to and interaction with an audience; the multi-media unit comprising means for creating a substantially continuous multi-media stream using a multi-media unit for substantially real-time display on a multi-media display unit; means for receiving, during the substantially real-time display of the multi-media output stream, multi-media content from persons in the audience via one or more multi-media devices, wherein said multi-media devices are remotely coupled to the multi-media unit; means for providing a user interface for accessing and manipulating said received multi-media input; and means for incorporating at least a portion of said received multi-media content into the substantially continuous multi-media stream.

In accordance with a third aspect of the present invention there is provided a data storage medium having computer code means for instructing a computer device to execute a method of creating a multi-media output for presentation to a live audience; the method comprising the steps of playing a substantially continuous multi-media clip using a multi-media unit for substantially real-time display on a display unit; receiving, during the substantially real-time display of the multi-media clip, multi-media content from one or more persons in the live audience via one or more multi-media devices, wherein said multi-media devices are remotely coupled to the multi-media unit; providing a user interface of the multi-media unit for accessing and manipulating said received multi-media content; and incorporating at least a portion of said received multi-media content into the substantially continuous multi-media clip using the multi-media unit.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic block diagram of an integrated portable hardware console according to an example embodiment.

FIG. 2, is a schematic diagram illustrating application of an IMJ system according to an example embodiment.

FIG. 3 shows a schematic block diagram illustrating an overview of the content flow and manipulation in an IMJ system according to an example embodiment.

FIG. 4 shows a schematic block diagram illustrating the software and hardware modules of an IMJ system according to an example embodiment.

FIG. 5 shows an example screen shot of creatively generated real-time substantially continuous multi-media clips generated at the flash interface of an IMJ system according to an example embodiment.

FIG. 6 shows an example screen shot of creatively generated real-time substantially continuous multi-media clips generated at the flash interface of an IMJ system according to an example embodiment.

FIG. 7 shows a flow chart illustrating a method of creating a multi-media output for presentation to and interaction with a live audience according to an example embodiment.

### DETAILED DESCRIPTION

The example embodiments described provide an Interactive Multimedia Jockey (iMJ) system and hardware console to produce interactive multimedia with inputs from live audience. A multimedia jockey (MJ) spins multimedia inputs from his own collection as well as from the live audience to facilitate interaction between them.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following; it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

The interactive Multimedia Jockey (IMJ) system in an example embodiment allows the MJ to create new multimedia content and provides him a seamless way to mix inputs from different technologies (SMS, MMS, GPRS, 3G, HSPDA, Web Browser/http) and multiple formats (bmp, gif, jpeg, avi, mov, mp4, 3gp, mpg, H.264) in his own special creative way. The IMJ system integrates various wired and wireless inputs including an integrated GSM modem, IMS (IP Multimedia Subsystem) clients and Web server. The IMJ system's multi-modal input mode allows an audience to participate as long as they have a communication device (any mobile phone, laptop etc). Users are able to make use of any form of connection, e.g. Internet, GSM, to interact with the IMJ system.

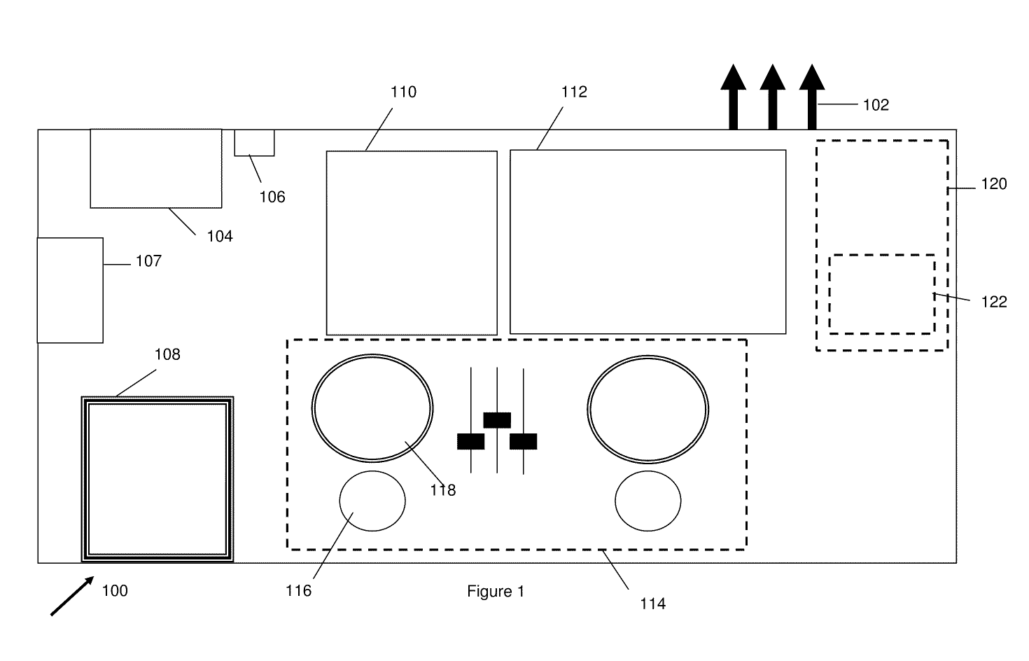

FIG. 1 shows a schematic block diagram of an integrated portable hardware console 100 which consists of high-definition outputs e.g. 102 to big screens, GSM/GPRS/HSPDA (for SMS/MMS/IMS) modem 104, Ethernet 106, a wireless Router 107 (for Wi-Fi), disc-changers e.g. 108, and two touch screens, (one control panel 110 and one preview screen for manipulation 112) in an example embodiment. The console 100 allows easy controls for the Multimedia Jockey. An integrated hardware mixing “keyboard” 114 including pad buttons e.g. 116, tactile shuttle wheels e.g. 118, allow the Multimedia Jockey (MJ) to ‘scratch’ the multimedia objects in a similar way a DJ scratches music. The Software tool allows the MJ to creatively modify the multimedia content such as morphing the objects, adding inputs and visualizations and more. The MJ can also create a different ‘skin’ for the IMJ to suit different events. As will be appreciated by a person skilled in the art, ‘skins’ are associated with themes as custom graphical appearances (GUIs) that can be applied to the presentation screen in order to suit the different tastes of different users or events. The IMJ software in an example embodiment is capable of having a skin applied, which is also referred to as being skinnable. Applying a skin changes the software's look and feel in different embodiments. The console 100 in the example embodiment incorporates two graphics card (not shown) with three outputs One graphics card is used for the on-board graphics with one output for the control panel 110 and the other graphics card with two outputs is used for the big screen and the other touch screen 112. The console 100 in the example embodiment also incorporates two sound cards (not shown), one for audio preview, and one for playback.

The integrated hardware mixing keyboard 114 may further comprise a mixing display (not shown). A mini customized PC 120 including a hard disk 122 provides the processing resources for execution of the various processing and software modules, which will be described in more detail below. As will be appreciated by a person skill in the art, the customized PC includes a processor, a random access memory (RAM) and a read only memory (ROM) in an example embodiment, as well as a number of input/output (I/O) interfaces, for example an I/O interface to the keyboard 114 including pad buttons e.g. 116 and tactile dial shuttle wheels e.g. 118, and I/O interfaces to the control panel touch screen 110 and preview touch screen 112, for example. The components of the customized PC typically communicate via an interconnected bus and in a manner known to the person skilled in the art. An application program is typically supplied to the customized PC encoded on a data storage medium such as a CD-ROM or flash memory carrier and read utilizing a corresponding data storage medium drive of a data storage device. The application program is read and controlled in its execution by the processor of the customized PC. Intermediate storage of program data may be accomplished using the RAM.

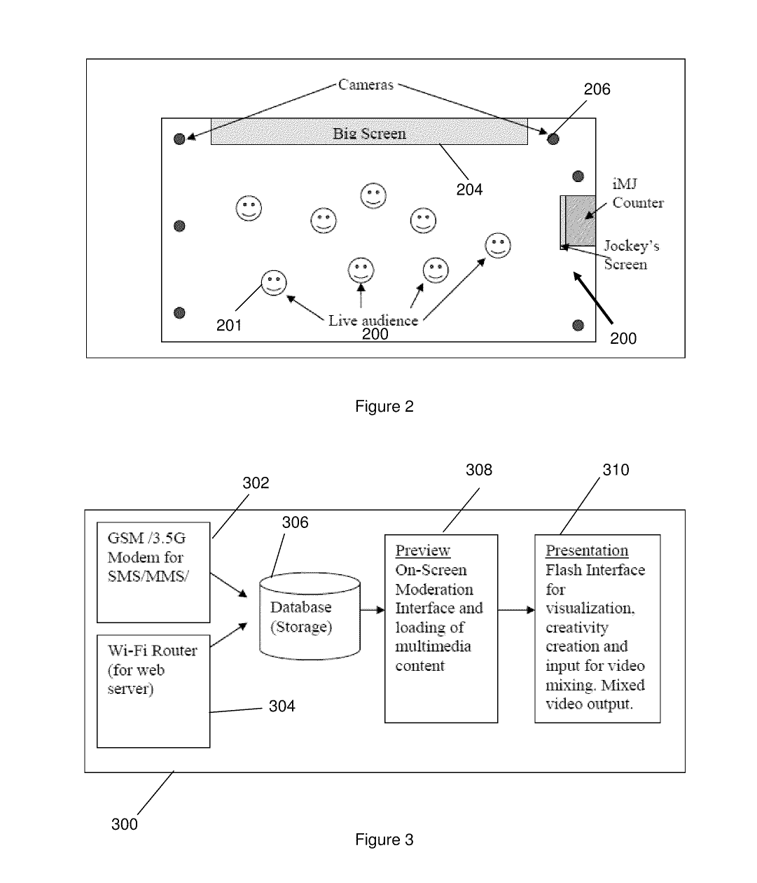

With reference to FIG. 2, the flow of the IMJ system 200 allows multiple media like SMS; MMS, Pictures, videos, music, text to be sent by users e.g. 201 in a live audience 202 to the IMJ system 200 and which will be moderated and mixed in a creative way to generate new multimedia content to be displayed on a big screen 204. Additionally, multimedia content created by the MJ can also be sent back to the users e.g. 201 to be viewed as a Video clip or set as a mobile video ring tone. The IMJ System 200 is a system that can be deployed in any public location with a big screen and allows real-time multimedia interactions between live audiences. Persons e.g. 201 in the live audience 202 can use their mobile device to send messages/objects to the IMJ System 200 which will be moderated by the MJ before displaying it on the big screen 204. Any of the mobile technologies like GSM/GPRS/3G/HSPDA or Wi-Fi can be used to send messages and multimedia objects to the IMJ system 200. The IMJ system 200 is also IMS compliant and is able to accept any IMS messages and multimedia objects sent via the IMS standard in the example embodiment.

FIG. 3 shows a schematic block diagram illustrating an overview of the content flow and manipulation in an IMJ system 300 according to an example embodiment. Content received e.g. via GMS/3.5G modem 302 for SMS/MMS, or via a Wi-Fi router 304 for a web server of the IMJ system sent by persons in the live audience are stored in a database, here in the form of a ASP.NET database 306 of the IMJ system. The MJ previews the content such as messages and multi-media objects via an on-screen moderation interface 308, the content being loaded from the database 306. A flash interface 310 for visualization in the example embodiment is provided for presenting the creative visualization of the content in a multi-media clip, i.e. a real-time substantially continuous multi-media clip is creatively generated incorporating multi-media content received from persons in the live audience. The generated multi-media clip can be directly and real-time displayed on a big screen via high definition outputs. Optionally, the clip can be input to conventional video mixing switching equipment either coupled to the IMJ system 300, or incorporated therein, for generating further mixed video output with other sources, such e.g. from cameras 206 (FIG. 2) for real-time display on the big screen.

The moderation interface 308 in an example embodiment employs the following modules, developed either as software applications on a general purpose computing device, or as dedicated functional hardware modules, for example implemented as respective ASICs:
a) IMS application
b) Video preview
c) Picture preview
d) Audio preview
e) Database access
f) Output to Flash application via XML
g) Text preview

The flash interface 310 in an example embodiment employs the following modules, developed either as software applications on a general purpose computing device, or as dedicated functional hardware modules, for example implemented as respective ASICs:
a) Flash application for creation and presentation of display content
b) On Screen video capture driver for capturing Flash application output for additional video mixing
c) Video mixing software.

In the example embodiment, all incoming content such as SMS messages, video uploads messages, MMS picture messages, and MMS video messages are converted into XML format. In the example embodiment, conversion takes place immediately upon receipt and prior to storage in the database.

Annexure I shows an example script for converting incoming SMS messages into XML format, according to an example embodiment.

Annexure II shows an example script for converting incoming video upload messages for playback in the flash application according to an example embodiment. Similarly, all incoming videos of various formats (e.g. 3GPP, MPEG 1, MPEG2, MPEG4 etc) are converted to a single format for playback in the flash application (e.g. flv format) prior to storage in the example embodiment. Tags of the video clips received are converted into XML format.

Annexure III shows an example script for converting incoming MMS picture messages into XML format according to an example embodiment.

Annexure IV shows an example script for converting incoming MMS video messages into XML format according to an example embodiment.

The (converted) XML messages are then read into a flash application, e.g. an Adobe flash application, of the flash interface 310 for creative visualization, i.e. creatively generating the real-time substantially continuous multi-media clip incorporating multi-media content received from persons in the live audience. Annexure IV shows an example script for reading the XML messages in flash to load videos, pictures and SMS, according to an example embodiment. As will be appreciated by a person skilled in the art, the example script in Annexure V provides routines for creative manipulation and incorporation of the loaded videos, pictures and SMS based on input from the MJ. The example script is responsive upon receipt of incoming messages automatically. It is event triggered. However, it will be appreciated that the script can be modified and/or additional scripts be provided in example embodiments for responsiveness to other means, such as capturing MJ input through various other means, including e.g. through the integrated hardware mixing “keyboard” 114 (FIG. 1), including pad buttons e.g. 116 (FIG. 1) and textile shuttle wheels e.g. 118 (FIG. 1), or input received via the touch screens 110, 112.

Annexure VI shows an example script for polling for newly received content every 5000 milliseconds and automatically incorporating the content “on the fly” into an ongoing flash clip.

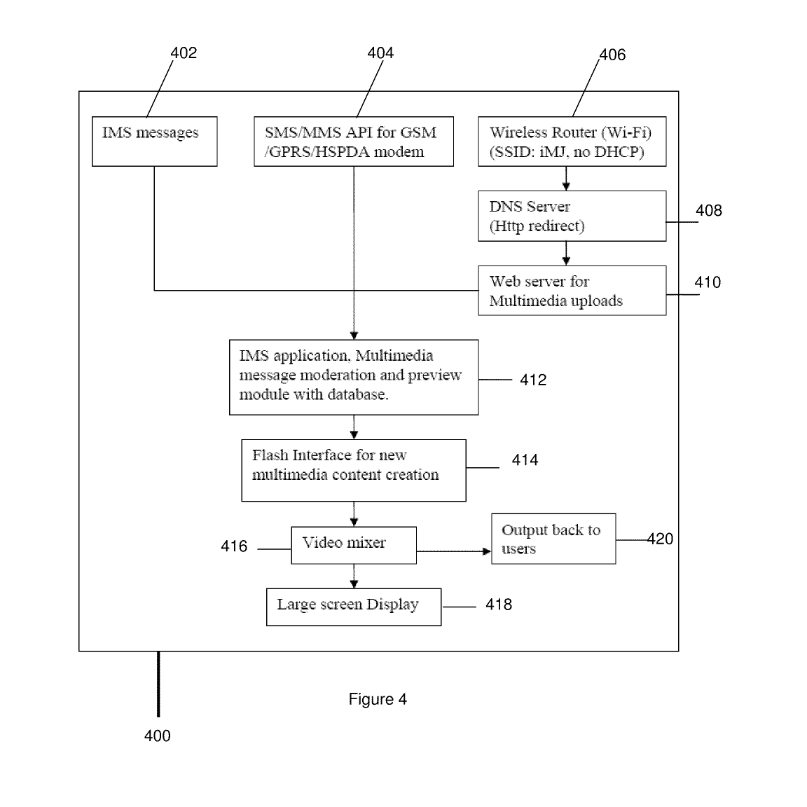

FIG. 4 shows a schematic block diagram illustrating the software and hardware modules of an IMJ system 400 according to an example embodiment. Here, the content receiving portion is divided into IMS messages module 402 for receiving IMS through the internet via either wireless (wi-fi) or Ethernet. In addition, an SMS/MMS application programming interface (API) 404 is provided for GMS/GPRS/HSPDA modem content receiving. Also, a wireless router (Wi-Fi) 406 is provided, in the example embodiment with a service set identifier (SSID) “iMJ”, with no dynamic host configuration protocol (DHCP) enablement. An Http redirect module 408 is provided for redirecting the Wi-Fi connections to a DNS server. In the example embodiment, a Tomcat server for employing a web input application is used. Input content at the DNS server, for example from the live audience, are uploaded using a Web server 410, in an example embodiment a JSP webpage for uploading of multimedia objects and messages.

The moderation interface 412 in this example embodiment comprises an IMS application, a multimedia message moderation and preview module, and including a database for storage of the received content. The moderation interface 412 is coupled to a flash interface 414 for creatively generating a real-time substantially continuous multi-media clip incorporating multi-media content received from persons in the live audience. The functionality of the flash interface 412 is substantially the same as for the flash interface 310 (FIG. 3) described above, and will not be repeated here.

In this example embodiment, an on screen video capture driver is used for capturing the flash application output from the flash interface 414 for additional video mixing using a video mixing software module 416. The output from the video mixer module 416, incorporating the real-time substantially continuous creatively generated video clip and optionally images from other sources mixed using the video mixer module 416, are then provided to a large screen display 418 via a high-definition output from the video mixer module 416. Additionally, output from the video mixer module 416 can be provided back to users such as persons in the live audience, as indicated at numeral 420, using appropriate transmission modules. Output from the video mixer module 416 is recorded as a video clip using on screen video capture driver and stored as a video file in an example embodiment. It can be sent to users as e.g. an IMS or MMS video clip.

The IMJ system in example embodiments provides a product for producing interactive multimedia with inputs from a live audience. This output from the system allows people to communicate using multimedia content and can be used in various scenarios limited only by the human imagination.

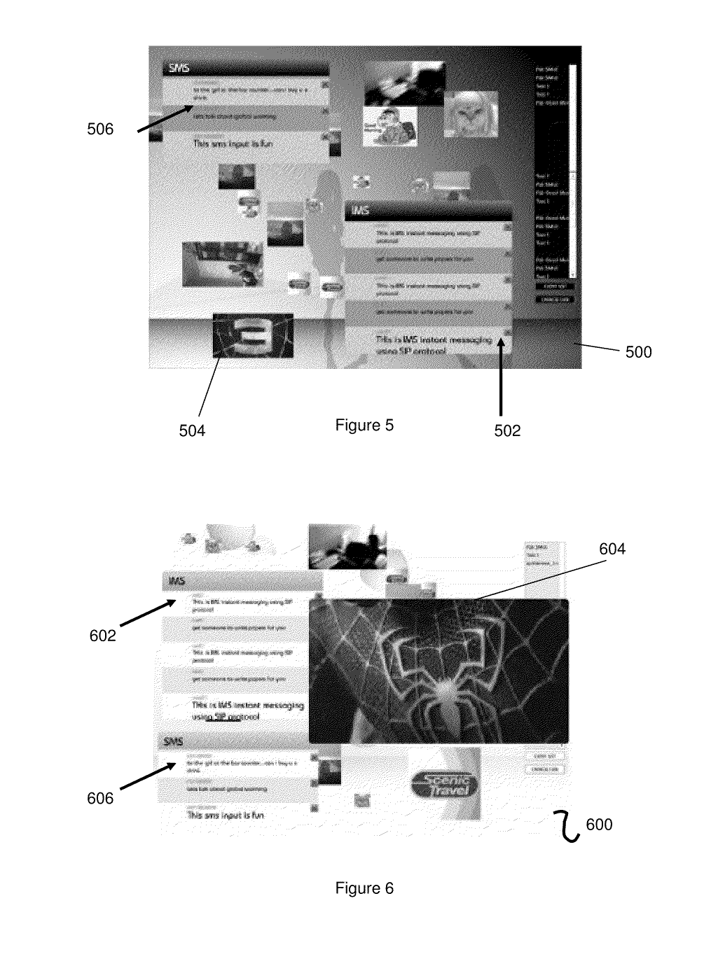

FIGS. 5 and 6 show example screen shots of creatively generated real-time substantially continuous multi-media clips generated at the flash interface of an IMJ system according to an example embodiment. Various multi-media content received from a live audience are incorporated into the clip, for example IMS panels 502, 602, uploaded video content e.g. 504, 604, and SMS panels e.g. 506, 606. As described above, the IMJ system according to example embodiments enables the MJ to creatively incorporate and manipulate the various multi-media contents in the real-time substantially continuous clips 500, 600, such as re-shaping of the objects, morphing of objects, the ability to alter (transform) the objects during actual playback through mouse interactions or system messages etc. Transforms supported in one embodiment are movements, scaling and rotation.

Annexure VII shows an example script for enabling interaction between the MJ and the audience-received content, according to an example embodiment. The flash application script polls for newly received information, i.e. audience-received content converted into XML format, and incorporates the content “on the fly” into an ongoing flash clip

Annexure VIII shows an example script for merging an SMS object with a photo object or a video object in the flash application, according to an example embodiment.

More particular, if an SMS object collides with a picture or video object, it will be loaded into the picture or video object.

Examples of applications the described embodiments include:

a) Wedding events: (currently) during a wedding, a power point slide or wedding video is made with friends and relatives giving their greetings and wishes before the event. The person creating the video usually has limited resources and input from friends and relatives as it is very costly and time consuming to visit or get input from everyone before the event. With the IMJ system according to an example embodiment, friends and relatives are able to give multimedia video clips during the wedding dinner or event. A virtual guest book video clip or image can be created with this system for guests to ‘sign’ or post messages and multimedia objects which will be mixed to create an image of all the wishes from the guests.

b) Concerts: Current concerts have projectors with visualizations and footage of the artists and audiences. The IMJ system according to an example embodiment allows the audiences to send in their own multimedia content like fan messages to the artists, pictures, video clips et cetera to the big projected screens.

c) Forums: Current forums allow people to write questions to the presenters in paper and assistants need to move around to collect their questions or feedback. The IMJ system according to an example embodiment allows them to post the questions up and everyone is able to view the questions rather than the presenters reading out the questions with no other form of reference for the audience.

d) Café, Pubs: Traditionally, people are only able to interact with people in the café or pubs by going up to them to talk. The IMJ system according to an example embodiment would allow them to interact with a stranger to strike up a conversation, or have a discussion using multimedia content that is self created in the pub or café.

e) Shopping malls: Advertisements are usually static or confined to one advertiser per screen. If multiple advertisers are advertising on a screen, they would need to queue and advertisers can only pre-load them and are unable to change them dynamically in real time. The IMJ system according to an example embodiment, advertisers can interact directly with the consumers using real time advertising messages and multimedia objects.

f) Disco: In a disco, visualizations are usually done to make the place look more exciting. However, the Video jockeys do not get input from the people in the disco. The IMJ system according to an example embodiment, the Video jockey can spin visualizations based on inputs from the crowd.

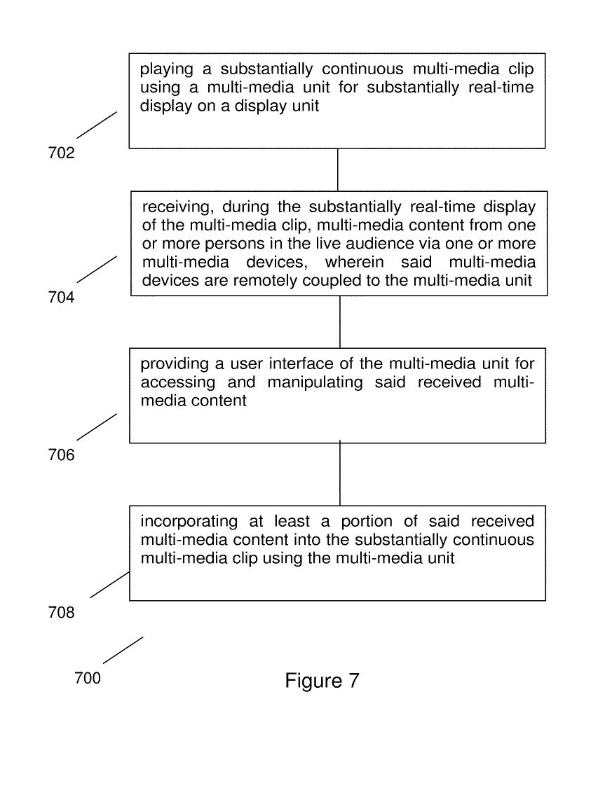

FIG. 7 shows a flowchart 700 illustrating a method of creating a multi-media output for presentation to and interaction with a live audience according to an example embodiment. At step 702, a substantially continuous multi-media clip is played using a multi-media unit for substantially real-time display on a display unit. At step 704, multi-media content is received during the substantially real-time display of the multi-media clip, from one or more persons in the live audience via one or more multi-media devices, wherein said multi-media devices are remotely coupled to the multi-media unit. At step 706, a user interface of the multi-media unit is provided for accessing and manipulating said received multi-media content. At step 708, at least a portion of said received multi-media content is incorporating into the substantially continuous multi-media clip using the multi-media unit.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

### ANNEXURE I

### Converting Incoming SMS Messages

```
private void ConvertSMS(object sender, EventArgs e)
    {
      try
      {
        //make connection
        OleDbConnection cn = new OleDbConnection( );
        cn.ConnectionString = “Provider=Microsoft.JET.OLEDB.4.0;” + @“data source =
C:\imj\db\SMSLog.mdb”;
        cn.Open( );
        //Create sql statement
        string strSQL = “SELECT MsgIndex, HPnums, Message FROM MsgRead WHERE [read]=‘N’ ”;
        OleDbCommand myCommand = new OleDbCommand(strSQL, cn);
        //obtain a data reader ala excuteReader( )
        OleDbDataReader myDataReader;
        myDataReader = myCommand.ExecuteReader( );
        //loop over the results
        string filename = “c:/imj/sms.xml”;
        XmlDocument xmlDoc = new XmlDocument( );
        try
        {
          xmlDoc.Load(filename);
        }
        catch (System.IO.FileNotFoundException)
        {
          //if file is not found, create a new xml file
          XmlTextWriter xmlWriter = new XmlTextWriter(filename, System.Text.Encoding.UTF8);
          xmlWriter.Formatting = Formatting.Indented;
          xmlWriter.WriteProcessingInstruction(“xml”, “version=‘1.0’ encoding=‘UTF-8’”);
          xmlWriter.WriteStartElement(“sms”);
          //If WriteProcessingInstruction is used as above,
          //Do not use WriteEndElement( ) here
          //xmlWriter.WriteEndElement( );
          //it will cause the <Root></Root> to be <Root />
          xmlWriter.Close( );
          xmlDoc.Load(filename);
        }
        while (myDataReader.Read( ))
        {
          //MessageBox.Show(“MsgIndex :” + myDataReader[“MsgIndex”].ToString( ));
          XmlNode root = xmlDoc.DocumentElement;
          XmlElement childNode = xmlDoc.CreateElement(“sms”);
          XmlElement childNode2 = xmlDoc.CreateElement(“sms”);
          XmlText textNode = xmlDoc.CreateTextNode(“sms”);
          textNode.Value = “This is for SMS”;
          root.AppendChild(childNode);
          childNode.SetAttribute(“text”, myDataReader[“Message”].ToString( ));
          childNode.SetAttribute(“pp”, myDataReader[“HPnums”].ToString( ));
          childNode.SetAttribute(“pic”, null);
          childNode.SetAttribute(“index”, myDataReader[“MsgIndex”].ToString( ));
          string currentindex = myDataReader[“MsgIndex”].ToString( );
          //Update field to add into xml file once.
          string updateSQL = “UPDATE MsgRead SET [Read] = ‘Y’ WHERE MsgIndex = ” + currentindex
          OleDbCommand myCommand1 = new OleDbCommand(updateSQL, cn);
          myCommand1.ExecuteNonQuery( );
        }
        xmlDoc.Save(filename);
        //close database connection
        myDataReader.Close( );
        cn.Close( );
      }
      catch (Exception ex)
      {
        WriteError(ex.ToString( ));
      }
    }
```

### ANNEXURE II

### Converting Incoming Video Uploads Messages

```
//for internet uploading of video files via WiFi
private void StartRead_Click(object sender, EventArgs e)
    {
      //track the video.txt file which will change when a file is uploaded via jsp Tomcat
      FileSystemWatcher fileSystemWatcher = new FileSystemWatcher( );
      fileSystemWatcher.Path = “C:\\imj”;
      fileSystemWatcher.NotifyFilter = NotifyFilters.LastAccess;//.LastWrite;
      fileSystemWatcher.Filter = “videos.txt”;
      fileSystemWatcher.Changed += new FileSystemEventHandler(OnChanged);
      fileSystemWatcher.EnableRaisingEvents = true;
    }
private void OnChanged(object source, FileSystemEventArgs e)
    {
      //when the videos.txt file is changed
      if(e.ChangeType== WatcherChangeTypes.Changed)
      {
        videoxml( );
        MessageBox.Show(e.FullPath + e.ChangeType);
        //fires 2 events due to antivirus ???!!
        System.Threading.Thread.Sleep(1000);
      }
    }
private void videoxml( )
    {
      //convert the video file to flv and write to videos.xml file
      try
      {
        //read from file
        TextReader tr = new StreamReader(“c:/imj/videos.txt”);
        int NumberOfLines = 3;
        string[ ] ListLines = new string[NumberOfLines];
        for (int i = 0; i < NumberOfLines; i++)
        {
          ListLines[i] = tr.ReadLine( );
        }
        string videopath = ListLines[0];
        string videoname = ListLines[1];
        string counter = ListLines[2];
        string element;
        string filename;
        tr.Close( );
        if (videoname.EndsWith(“jpg”) || videoname.EndsWith(“gif”))
        {
          filename = “c:/imj/pic.xml”;
          element = “pic”;
        }
        else if (videoname.EndsWith(“flv”))
        {
          filename = “c:/imj/videos.xml”;
          element = “videos”;
        }else
        {
          //pick whatever filename with .xml extension
          filename = “c:/imj/videos.xml”;
          element = “videos”;
          string strcmd = “c:/imj/ffmpeg/ffmpeg −y −i ” + videopath + “ −f flv −vcodec flv ” + videopath +
“.flv”;
          System.Diagnostics.ProcessStartInfo processStartInfo = new
System.Diagnostict.ProcessStartInfo(“cmd.exe”, “/C ” + strcmd);
          processStartInfo.UseShellExecute = false;
          System.Diagnostics.Process proc = System.Diagnostics.Process.Start(processStartInfo);
          proc.WaitForExit(20000);
          proc.Close( );
          videopath = videopath + “.flv”;
          videoname = videoname + “.flv”;
          try
          {
            //make connection
            OleDbConnection cn = new OleDbConnection( );
            string myConnectionString = “Provider=Microsoft.JET.OLEDB.4.0;” + @“data source =
C:\imj\db\SMSLog.mdb”;
            OleDbConnection myConnection = new OleDbConnection(myConnectionString);
            string myInsertQuery = “INSERT INTO MmsRead (HPnums, MMSContent,[Status]) VALUES
(‘Web upload’,‘“ + videopath + ’”,‘Y’) ”;
            OleDbCommand myCommand = new OleDbCommand(myInsertQuery);
            myCommand.Connection = myConnection;
            myConnection.Open( );
            myCommand.ExecuteNonQuery( );
            myCommand.Connection.Close( );
          }
          catch (Exception ex)
          {
            WriteError(ex.ToString( ));
          }
        }
        XmlDocument xmlDoc = new XmlDocument( );
        try
        {
          xmlDoc.Load(filename);
        }
        catch (System.IO.FileNotFoundException)
        {
          //if file is not found, create a new xml file
          XmlTextWriter xmlWriter = new XmlTextWriter(filename, System.Text.Encoding.UTF8);
          xmlWriter.Formatting = Formatting.Indented;
          xmlWriter.WriteProcessingInstruction(“xml”, “version=‘1.0’ encoding=‘UTF-8’”);
          xmlWriter.WriteStartElement(element);
          //If WriteProcessingInstruction is used as above,
          //Do not use WriteEndElement( ) here
          //xmlWriter.WriteEndElement( );
          //it will cause the <Root></Root> to be <Root />
          xmlWriter.Close( );
          xmlDoc.Load(filename);
        }
        //MessageBox.Show(“MsgIndex :” + myDataReader[“MsgIndex”].ToString( ));
        XmlNode root = xmlDoc.DocumentElement;
        XmlElement childNode = xmlDoc.CreateElement(element);
        XmlElement childNode2 = xmlDoc.CreateElement(element);
        XmlText textNode = xmlDoc.CreateTextNode(“hello”);
        textNode.Value = “This is for video file upload”;
        root.AppendChild(childNode);
        childNode.SetAttribute(“url”, videopath);
        childNode.SetAttribute(“desc”, videoname);
        childNode.SetAttribute(“id”, counter);
        //childNode.AppendChild(childNode2);
        //childNode2.SetAttribute(“text”, this.ContentForWriteHelper.Text);
        //childNode2.AppendChild(textNode);
        //textNode.Value = “replacing hello world”;
        xmlDoc.Save(filename);
      }
      catch (Exception ex)
      {
        WriteError(ex.ToString( ));
      }
    }
```

### ANNEXURE III

### 3) Converting Incoming MMS Picture Messages

```
    private void MmsPics_Click(object sender, EventArgs e)
    {
      try
      {
        //make connection
        OleDbConnection cn = new OleDbConnection( );
        cn.ConnectionString = “Provider=Microsoft.JET.OLEDB.4.0;” + @“data source =
C:\imj\db\SMSLog.mdb”;
        cn.Open( );
        //Create sql statement
        string strSQL = “SELECT MsgIndex, HPnums, Subject FROM MMSRead WHERE [Status] = ‘N’”;
        OleDbCommand myCommand = new OleDbCommand(strSQL, cn);
        //obtain a data reader ala excuteReader( )
        OleDbDataReader myDataReader;
        myDataReader = myCommand.ExecuteReader( );
        //loop over the results
        //pick whatever filename with .xml extension
        string filename = “c/imj/pic.xml”;
        XmlDocument xmlDoc = new XmlDocument( );
        try
        {
          xmlDoc.Load(filename);
        }
        catch (System.IO.FileNotFoundException)
        {
          //if file is not found, create a new xml file
          XmlTextWriter xmlwriter = new XmlTextWriter(filename, System.Text.Encoding.UTF8);
          xmlWriter.Formatting = Formatting.Indented;
          xmlWriter.WriteProcessingInstruction(“xml”, “version=‘1.0’ encoding=‘UTF-8”’);
          xmlWriter.WriteStartElement(“pic”);
          //If WriteProcessingInstruction is used as above,
          //Do not use WriteEndElement( ) here
          //xmlWriter.WriteEndElement( );
          //it will cause the <Root></Root> to be <Root />
          xmlWriter.Close( );
          xmlDoc.Load(filename);
        }
        while (myDataReader.Read( ))
        {
          //MessageBox.Show(“MsgIndex :” + myDataReader[“MsgIndex”].ToString( ));
          string filepath;
          string txtFileContents;
          try
          {
            string currentindex = myDataReader[“MsgIndex”].ToString( );
            //Update field to add into xml file once.
            string updateSQL = “UPDATE MmsRead SET [Status] = ‘Y’ WHERE MsgIndex = ” +
currentindex;
            OleDbCommand myCommand1 = new OleDbCommand(updateSQL, cn);
            myCommand1.ExecuteNonQuery( );
            filepath = “c:/imj/mms/file/” + myDataReader[“MsgIndex”].ToString( );
            try
            {
              //read txt file for mms text msg
              string[ ] txtFilePath = System.IO.Directory.GetFiles(filepath, “*.txt”);
              string txtFile = txtFilePath[0].Replace(“\\”, “/”);
              TextReader tr = new Stream Reader(txtFile);
              // read a line of text
              txtFileContents = tr.ReadLine( );
              // close the stream
              tr.Close( );
            }
            catch (Exception ex)
            {
              txtFileContents = ex.ToString( );
            }
            string[ ] pictureFile = System.IO.Directory.GetFiles(filepath, “*.jpg”);
            if (pictureFile.Length == 0)
            {
              pictureFile = System.IO.Directory.GetFiles(filepath, “*.gif”);
              if (pictureFile.Length == 0)
              {
                pictureFile = System.IO.Directory.GetFiles(filepath, “*.jpeg”);
              }
              else
              {
                //file not found
                //pictureFile[0] = “\\”;
              }
            }
            filepath = pictureFile[0].Replace(“\\”, “/”);
            pictureFile = null;
            //get width and height for pic.xml file
            System.Drawing.Image image = System.Drawing.Image.FromFile(filepath);
            string imageWidth= image.Width.ToString( );
            string imageHeight = image.Height.ToString( );
            //filepath = pictureFile[0];
            XmlNode root = xmlDoc.DocumentElement;
            XmlElement childNode = xmlDoc.CreateElement(“pic”);
            XmlElement childNode2 = xmlDoc.CreateElement(“pic”);
            // XmlText textNode = xmlDoc.CreateTextNode(“hello”);
            // textNode.Value = “hello, world”;
            root.AppendChild(childNode);
            childNode.SetAttribute(“url”, filepath);
            childNode.SetAttribute(“msg”, txtFileContents);
            childNode.SetAttribute(“desc”, myDataReader[“Subject”].ToString( ));
            childNode.SetAttribute(“pp”, myDataReader[“HPnums”].ToString( ));
            childNode.SetAttribute(“width1”, imageWidth);
            childNode.SetAttribute(“height1”, imageHeight);
            childNode.SetAttribute(“id”, myDataReader[“MsgIndex”].ToString( ));
            //childNode.AppendChild(childNode2);
            //childNode2.SetAttribute(“text”, this.ContentForWriteHelper.Text);
            //childNode2.AppendChild(textNode);
            //textNode.Value = “replacing hello world”;
          }
          catch (Exception exc)
          {
            WriteError(exc.ToString( ));
          }
        }
        xmlDoc.Save(filename);
        //close database connection
        myDataReader.Close( );
        cn.Close( );
      }
      catch (Exception ex)
      {
        WriteError(ex.ToString( ));
      }
    }
```

### ANNEXURE IV

### Converting Incoming MMS Video Messages

```
private void ConvertMMSVideo(object sender, EventArgs e)
    { //read mms video files
      try
      {
        //make connection
        OleDbConnection cn = new OleDbConnection( );
        cn.ConnectionString = “Provider=Microsoft.JET.OLEDB.4.0;” + @“data source =
C:\imj\db\SMSLog.mdb”;
        cn.Open( );
        //Create sql statement
        string strSQL = “SELECT MsgIndex, HPnums, Subject FROM MMSRead WHERE [Status] = ‘N’”;
        OleDbCommand myCommand = new OleDbCommand(strSQL, cn);
        //obtain a data reader ala excuteReader( )
        OleDbDataReader myDataReader;
        myDataReader = myCommand.ExecuteReader( );
        //loop over the results
        //pick whatever filename with .xml extension
        string filename = “c:/imj/videos.xml”;
        XmlDocument xmlDoc = new XmlDocument( );
        try
        {
          xmlDoc.Load(filename);
        }
        catch (System.IO.FileNotFoundException)
        {
          //if file is not found, create a new xml file
          XmlTextWriter xmlWriter = new XmlTextWriter(filename, System.Text.Encoding.UTF8);
          xmlWriter.Formatting = Formatting.Indented;
          xmlWriter.WriteProcessingInstruction(“xml”, “version=‘1.0’ encoding=‘UTF-8’”);
          xmlWriter.WriteStartElement(“videos”);
          //If WriteProcessingInstruction is used as above,
          //Do not use WriteEndElement( ) here
          //xmlWriter.WriteEndElement( );
          //it will cause the <Root></Root> to be <Root />
          xmlWriter.Close( );
          xmlDoc.Load(filename);
        }
        while (myDataReader.Read( ))
        {
          //MessageBox.Show(“MsgIndex :” + myDataReader[“MsgIndex”].ToString( ));
          string filepath;
          string txtFileContents;
          try
          {
            string currentindex = myDataReader[“MsgIndex”].ToString( );
            string updateSQL = “UPDATE MmsRead SET [Status] = ‘Y’ WHERE MsgIndex = ” +
currentindex;
            OleDbCommand myCommand1 = new OleDbCommand(updateSQL, cn);
            myCommand1.ExecuteNonQuery( );
            filepath = “c:/imj/mms/file/” + myDataReader[“MsgIndex”].ToString( );
            //read txt file for mms text msg
            string[ ] txtFilePath = System.IO.Directory.GetFiles(filepath, “*.txt”);
            string txtFile = txtFilePath[0].Replace(“\\”, “/”);
            TextReader tr = new Stream Reader(txtFile);
            // read a line of text
            txtFileContents = tr.ReadLine( );
            // close the stream
            tr.Close( );
            string[ ] videoFile = System.IO.Directory.GetFiles(filepath, “*.flv”);
            if (videoFile.Length == 0)
            {
              videoFile = System.IO.Directory.GetFiles(filepath, “*.mp4”);
              if (videoFile.Length == 0)
              {
                videoFile = System.IO.Directory.GetFiles(filepath, “*.3gp”);
                if (videoFile.Length == 0)
                {
                  videoFile = System.IO.Directory.GetFiles(filepath, “*.mov”);
                }
              }
              if (videoFile.Length == 0)
              {
              }
              else
              { //pictureFile not null
                filepath = videoFile[0].Replace(“\\”, “/”);
                string strcmd = “c:/imj/ffmpeg/ffmpeg −y −i ” + filepath + “ −f flv −vcodec flv ” + filepath +
“.flv”;
                System.Diagnostics.ProcessStartInfo processStartInfo = new
System.Diagnostics.ProcessStartInfo(“cmd.exe”, “/C ” + strcmd);
                processStartInfo.UseShellExecute = false;
                System.Diagnostics.Process proc =
System.Diagnostics.Process.Start(processStartInfo);
                proc.WaitForExit(20000);
                proc.Close( );
                videoFile[0] = filepath + “.flv”;
              }
            }
            filepath = videoFile[0].Replace(“\\”, “/”);
            videoFile = null;
            //filepath = videoFile[0];
            XmlNode root = xmlDoc.DocumentElement;
            XmlElement childNode = xmlDoc.CreateElement(“videos”);
            XmlElement childNode2 = xmlDoc.CreateElement(“videos”);
            //XmlText textNode = xmlDoc.CreateTextNode(“hello”);
            //textNode.Value = “hello, world”;
            root.AppendChild(childNode);
            childNode.SetAttribute(“flv”, filepath);
            childNode.SetAttribute(“msg”, txtFileContents);
            childNode.SetAttribute(“desc”, myDataReader[“Subject”].ToString( ));
            childNode.SetAttribute(“pp”, myDataReader[“HPnums”].ToString( ));
            childNode.SetAttribute(“id”, myDataReader[“MsgIndex”].ToString( ));
            //childNode.AppendChild(childNode2);
            //childNode2.SetAttribute(“text”, this.ContentForWriteHelper.Text);
            //childNode2.AppendChild(textNode);
            //textNode.Value = “replacing hello world”;
          }
          catch (Exception exc)
          {
            WriteError(exc.ToString( ));
          }
        }
        xmlDoc.Save(filename);
        //close database connection
        myDataReader.Close( );
        cn.Close( );
      }
      catch (Exception ex)
      {
        WriteError(ex.ToString( ));
      }
    }
```

### ANNEXURE V

### Interaction Between Multi Media Jockey and Audience

```
private void Send_Msg_Click(object sender, EventArgs e)
    {
    string Hpnums = HP_num.Text;
    string Smsmessage = SMS_text.Text;
    //make connection
    OleDbConnection cn = new OleDbConnection( );
    string myConnectionString =
“Provider=Microsoft.JET.OLEDB.4.0;” +
@“data source = C:\imj\db\SMSLog.mdb”;
    OleDbConnection myConnection = new
    OleDbConnection(myConnectionString);
    string myInsertQuery = “INSERT INTO MsgSent (MsgType,PortX,
HPnums, [Message] ,[Sent]) VALUES (‘SMS’,‘1’,‘“ + Hpnums +
”’,‘“ + Smsmessage + ”’,‘N’) ”;
    OleDbCommand myCommand = new
    OleDbCommand(myInsertQuery);
    myCommand.Connection = myConnection;
    myConnection.Open( );
    myCommand.ExecuteNonQuery( );
    myCommand.Connection.Close( );
    HP_num.Clear( );
    SMS_text.Clear( );
    }
```

### ANNEXURE VI

```
function refreshPic( ) {
    var MMS:XML = new XML( );
    MMS.ignoreWhite = true;
    MMS.load(“pic.xml”);
    MMS.onLoad = function(success) {
        if (success) {
            for (var i:Number = 0; i<this.firstChild.childNodes.length; i++) {
                var theMMS = new Object({src:this.firstChild.childNodes[i].attributes.url,
desc:this.firstChild.childNodes[i].attributes.desc,  width1:this.firstChild.childNodes[i].attributes.width1,
height1:this.firstChild.childNodes[i].attributes.height1,  id:this.firstChild.childNodes[i].attributes.id,
theType:“picture”, num:i});
                var smsXML = this.firstChild.childNodes;
                var PtheNo = new Object({total:smsXML.length});
                //-------no = original number of smsXML.length-------
                //-------theNo.total = current number of smsXML.length-----
                //-------if current><original then it refresh the SMS
                //---k=1 is to called the function loadVideos to generate the function in
k=1 rather than k=0-----------
                //-------when increase--------
                if (PtheNo.total−1>no) {
                    pic = 1;
                    a.unloadMovie( );
                    loadPictures( );
                    picNum++;
                    if (a._x == 238) {
                        a._x = 238;
                        Ptotal = PtheNo.total−10;
                        next1._visible = 100;
                        prev1._visible = 0;
                    } else {
                        Ptotal = PtheNo.total−no+Pkk1−1;
                        next1._visible = 100;
                    }
                }
                //-------when decrease--------
                if (PtheNo.total−1<no) {
                    pic = 1;
                    a.unloadMovie( );
                    loadPictures( );
                    picNum++;
                    if (a._x == 238) {
                        a._x = 238;
                        Ptotal = PtheNo.total−10;
                        next1._visible = 100;
                        prev1._visible = 0;
                    } else {
                        a._x = 575.0−(PtheNo.total*33)−((PtheNo.total−10)*33);
                        Ptotal = 0;
                        Ptot = PtheNo.total−10;
                        next1._visible = 0;
                        prev1._visible = 100;
                    }
                }
                if (PtheNo.total−1<10) {
                    a._x = 535.0−(PtheNo.total−1)*33;
                    next1._visible = 0;
                    prev1._visible = 0;
                    Ptotal = 0;
                    Ptot = 0;
                }
            }
        }
    };
}
picInterval = setInterval(refreshPic, 5000);
```

### ANNEXURE VII

### Read xml Messages in Flash to Load Videos, Pictures and sms

```
//-----load videos from vid.xml-----------
//----create thumbnails for videos---------
//----click on thumbnails to call for large version of video-------
function loadVideos( ) {
    var flv:XML = new XML( );
    flv.ignoreWhite = true;
    flv.load(“videos.xml”);
    flv.onLoad = function(success) {
        if (success) {
            for (var i:Number = 0; i<this.firstChild.childNodes.length; i++) {
                var vid = new Object({src:this.firstChild.childNodes[i].attributes.flv,
desc:this.firstChild.childNodes[i].attributes.desc,  width1:this.firstChild.childNodes[i].attributes.width1,
height1:this.firstChild.childNodes[i].attributes.height1,  id:this.firstChild.childNodes[i].attributes.id,
theType:“videos”, num:i});
                noo = vid.num;
                //--to load a empty container with numbers----
                tempMc = b.attachMovie(“mcEmpty”, vid.num, i*10);
                //-----set postion in the center--------
                if (k == 0) {
                    total = vid.num−9;
                    tot = 0;
                    if (noo<10) {
                        b._x = 535.0−noo*33;
                        next2._visible = 0;
                        prev2._visible = 0;
                    } else if (noo>=10) {
                        b._x = 238;
                        next2._visible = 100;
                        prev2._visible = 0;
                    }
                }
                //------------shift the thumbnails------------------
                //--the variable of total/tot is deducted when next2/prev2 is click----
                //--kk1/kk2 is the “click” left from total/tot-----
                next2.onPress = function( ) {
                    b._x = b._x−61;
                    total = total−1;
                    tot = tot+1;
                    kk1 = total;
                    kk2 = tot;
                    prev2._visible = 100;
                    if (total == 0) {
                        this._visible = 0;
                        this.gotoAndStop(“out”);
                    }
                };
                prev2.onPress = function( ) {
                    b._x = b._x+61;
                    total = total+1;
                    tot = tot−1;
                    kk1 = total;
                    kk2 = tot;
                    next2._visible = 100;
                    if (tot == 0) {
                        this._visible = 0;
                        this.gotoAndStop(“out”);
                    }
                };
                //---to load the flv on top of tempMc-------
                //---attach video1 with different sources of videos
                //-this make this = _level10.b.Number.Name= _level10.b.1.IMJ_Final.flv-
                //--done so for the use in swapDepths ----
                temp = tempMc.attachMovie(“video1”, vid.src, i*10);
                temp._xscale = 20;
                temp._yscale = 20;
                temp._x = i*60;
                temp._alpha = 50;
                temp.onEnterFrame = function( ) {
                    var dx = this._x−_xmouse+b._x−5;
                    var dy = this._y−_ymouse+740;
                    var hyp = Math.sqrt((dx*dx)+(dy*dy));
                    var size = 37−hyp/5;
                    if (size<20) {
                        size = 20;
                    }
                    this.ds = (size−this._xscale)/10;
                    this._xscale += this.ds;
                    this._yscale = this._xscale;
                };
                temp.onRollOver = function( ) {
                    s = this._parent._parent;
                    f = this._parent._name/1;
                    s[f+2].swapDepths(s.getNextHighestDepth( ));
                    s[f−2].swapDepths(s.getNextHighestDepth( ));
                    s[f+1].swapDepths(s.getNextHighestDepth( ));
                    s[f−1].swapDepths(s.getNextHighestDepth( ));
                    this._parent.swapDepths(s.getNextHighestDepth( ));
                    //this.my_mc.pause( );
                    this._alpha = 100;
                };
                temp.onRollOut = function( ) {
                    //this.my_mc.pause( );
                    this._alpha = 50;
                };
                temp.onPress = function( ) {
                    //---------------------------------------------------------
                    //  To loaded a larger picture when click on each
thumbnails
                    //---------------------------------------------------------
                    var video = _root.attachMovie(“flvPlayer”, “vid”+picNum+“_mc”,
_root.getNextHighestDepth( ), {_x:randRange(25, 800), _y:randRange(20, 450)});
                    naming = this._name;
                    video._xscale = 30;
                    video._yscale = 30;
                    //---load in diff number of container-----
                    picNum++;
                    //------fly in and rotation transition--------
                    import mx.transitions.*;
                    import mx.transitions.easing.*;
                    TransitionManager.start(video,  {type:Fly,
direction:Transition.IN, duration:3, easing:Elastic.easeOut, startPoint:randRange(0, 9)});
                    TransitionManager.start(video,  {type:Rotate,
direction:Transition.IN, duration:3, easing:Strong.easeInOut, ccw:false, degrees:randRange(90, 720)});
                    //------------------------------------------
                    ee = 0;
                    this.onPress = function( ) {
                        if (ee == 0) {
                            picNum = picNum;
                        } else if (ee == 1) {
                            var video = _root.attachMovie(“flvPlayer”,
“vid”+picNum+“_mc”, _root.getNextHighestDepth( ), {_x:randRange(25, 800), _y:randRange(20, 450)});
                            naming = this._name;
                            video._xscale = 30;
                            video._yscale = 30;
                            //---load in diff number of container-----
                            picNum++;
                            //------fly in and rotation transition--------
                            import mx.transitions.*;
                            import mx.transitions.easing.*;
                            TransitionManager.start(video,  {type:Fly,
direction:Transition.IN, duration:3, easing:Elastic.easeOut, startPoint:randRange(0, 9)});
                            TransitionManager.start(video, {type:Rotate,
direction:Transition.IN, duration:3, easing:Strong.easeInOut, ccw:false, degrees:randRange(90, 720)});
                            ee = 0;
                        }
                    };
                };
            }
        }
    };
}
//---------refresh Videos--------------
function refreshVid( ) {
    var flv:XML = new XML( );
    flv.ignoreWhite = true;
    flv.load(“videos.xml”);
    flv.onLoad = function(success) {
        if (success) {
            for (var i:Number = 0; i<this.firstChild.childNodes.length; i++) {
                var vid = new Object({src:this.firstChild.childNodes[i].attributes.flv,
desc:this.firstChild.childNodes[i].attributes.desc, width1:this.firstChild.childNodes[i].attributes.width1,
height1:this.firstChild.childNodes[i].attributes.height1, theType:“videos”, num:i});
                var smsXML = this.firstChild.childNodes;
                var theNo = new Object({total:smsXML.length});
                //-------noo = original number of smsXML.length-------
                //-------theNo.total = current number of smsXML.length-----
                //-------if current><original then it refresh the SMS
                //---k=1 is to called the function loadVideos to generate the function in
k=1 rather than k=0------------
                //--------when increase---------
                if (theNo.total−1>noo) {
                    k = 1;
                    b.unloadMovie( );
                    loadVideos( );
                    if (b._x == 238) {
                        b._x = 238;
                        total = theNo.total−10;
                        next2._visible = 100;
                        prev2._visible = 0;
                    } else {
                        total = theNo.total−noo+kk1−1;
                        next2._visible = 100;
                    }
                }
                //--------when decrease---------
                if (theNo.total−1<noo) {
                    k = 1;
                    b.unloadMovie( );
                    loadVideos( );
                    if (b._x == 238) {
                        b._x = 238;
                        total = theNo.total−10;
                        next2._visible = 100;
                        prev2._visible = 0;
                    } else {
                        b._x = 575.0−(theNo.total*33)−((theNo.total−10)*33);
                        total = 0;
                        tot = theNo.total−10;
                        next2._visible = 0;
                        prev2._visible = 100;
                    }
                }
                if (theNo.total−1<10) {
                    b._x = 535.0−(theNo.total−1)*33;
                    next2._visible = 0;
                    prev2._visible = 0;
                    total = 0;
                    tot = 0;
                }
            }
        }
    };
}
```

### ANNEXURE VIII

### Merge SMS Object with Photo Object or Video Object in Flash

```
//if an sms object collides with a picture or video object, it will be loaded
into the picture or video object.
if (_root.pictureObjectid, hittest(_root.smsObjectid) )
{
    pictureObjectHolderid.loadMovie(_root.smsObjectid);
    removeMovieClip(_root.smsObjectid);
}
```

1. A method of creating a multi-media output for presentation to and interaction with a live audience; the method comprising the steps of:
playing a substantially continuous multi-media clip using a multi-media unit for substantially real-time display on a display unit;
receiving, during the substantially real-time display of the multi-media clip, multi-media content from one or more persons in the live audience via one or more multi-media devices, wherein said multi-media devices are remotely coupled to the multi-media unit;
providing a user interface of the multi-media unit for accessing and manipulating said received multi-media content; and
incorporating at least a portion of said received multi-media content into the substantially continuous multi-media clip using the multi-media unit.

2. The method as claimed in claim 1, wherein the user interface is further provided for manipulating said incorporated portion of said received multi-media content during playing of the substantially continuous multi-media clip.

3. The method as claimed in claim 1, further comprising converting the received multi-media content into a format suitable for playback in an application program for playing the substantially continuous multi-media clip.

4. The method as claimed in claim 3, wherein incorporating said portion of said received multi-media content comprises adding said portion of said received multi-media content as an object into said substantially continuous multi-media clip.

5. The method as claimed in claim 1, wherein said received multi-media content is responsive to a previous multi-media content displayed on the display unit.

6. A multi-media unit for creating a multi-media output for presentation to and interaction with an audience; the multi-media unit comprising:
means for creating a substantially continuous multi-media stream using a multi-media unit for substantially real-time display on a multi-media display unit;
means for receiving, during the substantially real-time display of the multi-media output stream, multi-media content from persons in the audience via one or more multi-media devices, wherein said multi-media devices are remotely coupled to the multi-media unit;
means for providing a user interface for accessing and manipulating said received multi-media input; and
means for incorporating at least a portion of said received multi-media content into the substantially continuous multi-media stream.

7. A data storage medium having computer code means for instructing a computer device to execute a method of creating a multi-media output for presentation to and interaction with a live audience; the method comprising the steps of:
playing a substantially continuous multi-media clip using a multi-media unit for substantially real-time display on a display unit;
receiving, during the substantially real-time display of the multi-media clip, multi-media content from one or more persons in the live audience via one or more multi-media devices, wherein said multi-media devices are remotely coupled to the multi-media unit;
providing a user interface of the multi-media unit for accessing and manipulating said received multi-media content; and
incorporating at least a portion of said received multi-media content into the substantially continuous multi-media clip using the multi-media unit.

8. The method as claimed in 2, further comprising converting the received multi-media content into a format suitable for playback in an application program for playing the substantially continuous multi-media clip.

9. The method as claimed in claim 8, wherein incorporating said portion of said received multi-media content comprises adding said portion of said received multi-media content as an object into said substantially continuous multi-media clip.
